(19) United States
(12) Patent Application Publication
(10) Pub. No.: US 2006/0055617 A1
(43) Pub. Date: Mar. 16, 2006

(54) Integrated antenna matching network

(75) Inventor: David Malcolm Hall, Lockleys (AU)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Tagsys SA, La Penne-Sur Huveaune (FR)

(21) Appl. No.: 11/225,261

(22) Filed: Sep. 13, 2005

(30) Foreign Application Priority Data
Sep. 15, 2004 (AU) 2004905273

(51) Int. Cl. H01Q 1/50

(52) U.S. Cl. 343/850; 343/852

(57) ABSTRACT

A network is disclosed for matching impedance of an antenna including a first conducting layer to a circuit impedance. The network is adapted to modify at least reactance of the antenna impedance to be substantially equal in magnitude and opposite in sign relative to the circuit impedance. The network includes a first component for modifying the reactance. The first component may form a capacitance in series with the antenna. The network also includes a second component for modifying resistance and the reactance of the antenna impedance. The second component may form a capacitance in parallel with the antenna. The first and second components preferably comprise a second conducting layer adjacent the first layer.

### FIELD OF THE INVENTION

The present invention relates to a network for matching impedance of an antenna to a circuit impedance. The impedance matching may be adapted to improve radiated power and/or to tailor operational bandwidth. The present invention has particular application in the field of radio frequency identification (RFID) tags that may be attached to objects and used to identify, sort, control and/or audit the objects. In any event the invention may be useful in applications in which it is desirable to maintain the size of an antenna and circuit as small as possible.

### BACKGROUND OF THE INVENTION

The RFID tags may be part of an object management system and may include information passing between an interrogator which creates an electromagnetic interrogation field, and the RFID tags, which may respond by issuing a reply signal that is detected by the interrogator, decoded and consequently supplied to other apparatus in the sorting, controlling or auditing process. The objects to which the tags may be attached include animate or inanimate objects. In some variants of the system the frequency of the interrogation field may range from LF to UHF or microwave.

Under normal operation the tags may be passive, i.e. they may have no internal energy source and may obtain energy for their reply from the interrogation field, or they may be active and may contain an energy source, for example a battery. Such tags may respond only when they are within or have recently passed through the interrogation field. The interrogation field may include functions such as signalling to an active tag when to commence a reply or series of replies or in the case of passive tags may provide energy for passive tag operations along with any signalling.

A tag may contain at least two primary components including, an antenna that provides an interface to a data transfer medium, and an electronic circuit that contains data and/or identity information together with support functions including, but not limited to, reply generation and power supply. The antenna may be constructed from several layers or parts, including but not limited to, a conductor, a supporting substrate, conductive or dielectric coatings or deposits, protective laminations, adhesives, and one or more partial layers or insulated bridges used for conductor crossovers. The electronic circuit typically includes a substrate containing a microelectronic circuit or circuits together with external components that are or may be required for operation of the tag. For reasons such as production cost, performance, or integrability, the external components may or may not be included on the substrate containing the microelectronic circuit(s). Examples of the external components may include, but are not limited to, resistors, capacitors, diodes or thermistors.

In order to optimise a tag's reading performance it is desirable to match the impedance of the antenna to that of the electronic circuit. Matching the impedance of the antenna to the electronic circuit may provide optimum or maximum power transfer, e.g. for maximum read range of a passive tag. Matching between the impedances may also extend operating bandwidth, e.g. for appropriate operation of a passive tag in the context of international band allocations and/or a lower noise floor, e.g. in the receiver of an active tag.

The present invention may provide a procedure for integrating components of a matching network between an antenna and an electronic circuit into the antenna and associated substrate such that the tag may be constructed substantially from two components, those components being the electronic circuit and an antenna that is preferably no larger than that required for a desired operating range.

The present invention has particular benefit when applied to design of small UHF tags used for global applications, wherein such tags may be required to operate over approximately 100 MHz from 860 MHz to 960 MHz. Such applications are common, inter alia, to the logistics, pharmaceutical and courier industries.

### SUMMARY OF THE INVENTION

A typical matching network may provide maximum power transfer between an antenna and an associated electronic circuit. Maximum transfer of power between the antenna and circuit occurs when the impedance of the antenna is substantially equal to the complex conjugate of the impedance of the circuit. The complex conjugate of an impedance Z=R+jX is Z=R−jX, i.e. the reactive part (jX) is equal in magnitude but opposite in sign (note: “+” denotes an inductive reactance while “−” denotes a capacitive reactance).

The extent of reflection Γ (the Greek letter Gamma) that takes place at an interface between the antenna and the associated circuit is represented by the following expression:

$$Γ = \frac{{Z}_{ant} - {Z}_{chip}}{{Z}_{ant} + {Z}_{chip}} \qquad ( 1 )$$

The transmission factor representing the power that passes the interface is defined as (1−Γ²). A transmission factor of unity denotes that all available power from the antenna is transferred to the associated circuit. Although unity represents an idealised lossless case, factors close to unity are achievable in practice.

In an UHF passive circuit that requires rectification of the reader carrier, the input impedance may typically be capacitive, e.g. 20−j200 ohms. For maximum power transfer the associated antenna should exhibit an opposite, i.e. an inductive reactance (20+j200 ohms).

In order for an electric UHF antenna to exhibit an inductive reactance (+j200 ohms), the physical dimensions of the antenna should be close to half a wavelength in length, or by using common shortening techniques around one quarter of a wavelength. Antennas shorter than this will have a resistive part (R) less than the associated circuit and will have a capacitive reactance (−jX) requiring matching.

In order for a magnetic UHF antenna to exhibit an inductive reactance (+j200 ohms), the physical dimensions of the antenna should be around one twenty-fifth of a wavelength with the resistive part (R) being much smaller than the associated circuit. Antennas larger than this will have an increased resistive part but will be too inductive, such that both parts will require matching.

While a good match is preferred, when small antennas are used the components required for matching can be similar in size to the antenna itself, which if not integrated will combine to form an antenna that is approximately twice the size intended, placing into question the original choice of antenna, since a simple choice of a larger antenna without matching might suffice.

According to the present invention there is provided a network for matching impedance of an antenna including a first conducting layer to a circuit impedance, said network being adapted to modify at least reactance of said antenna impedance to be substantially equal in magnitude and opposite in sign relative to said circuit impedance and including a first component for modifying said reactance and a second component for modifying resistance and said reactance of said antenna impedance.

In a preferred embodiment the network may be adapted to modify the antenna impedance to be substantially equal to the complex conjugate of the circuit impedance.

The first layer may include a relatively thin metal conductor such as copper bonded to a dielectric substrate. Alternatively, the first layer may be formed on the substrate via conductive ink. The first component preferably forms a capacitance in series with the antenna. The second component preferably forms a capacitance in parallel with the antenna. The first and second components preferably comprise a second conducting layer adjacent the first layer. The first layer may be in the form of a loop. The loop may include at least one break providing terminals for connection to the circuit impedance. The second component may include parasitic capacitance between the terminals. The circuit impedance preferably is associated with an integrated microcircuit of an RFID tag.

According to a further aspect of the present invention there is provided a method for matching impedance of an antenna including a first conducting layer to a circuit impedance, said method being adapted to modify at least reactance of said antenna impedance to be substantially equal in magnitude and opposite in sign relative to said circuit impedance, said method including the steps of:
forming a first component for modifying said reactance; and
forming a second component for modifying resistance and said reactance of said antenna impedance.

In a preferred embodiment the method may be adapted to modify the antenna impedance to be substantially equal to the complex conjugate of the circuit impedance.

### DESCRIPTION OF A PREFERRED EMBODIMENT

A preferred embodiment of the present invention will now be described with reference to the accompanying drawings wherein:

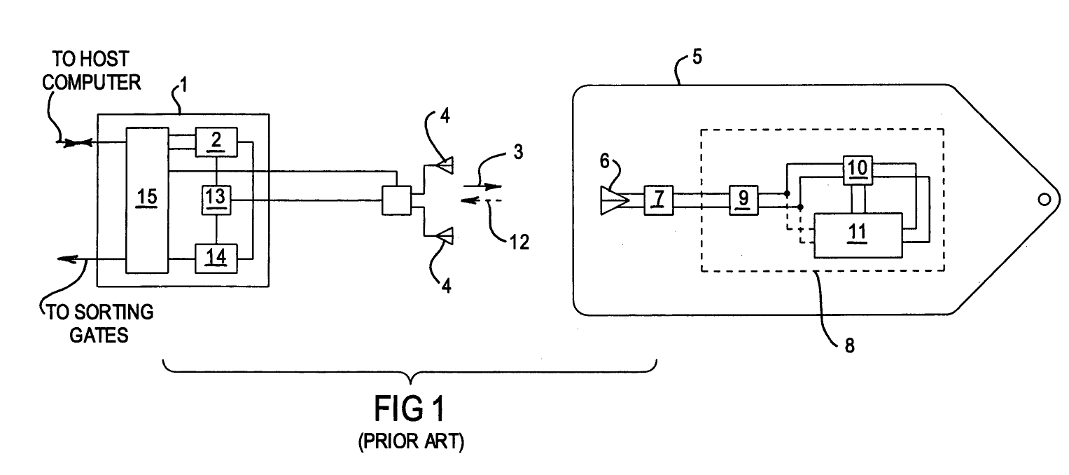

FIG. 1 shows major elements of a prior art object management system;

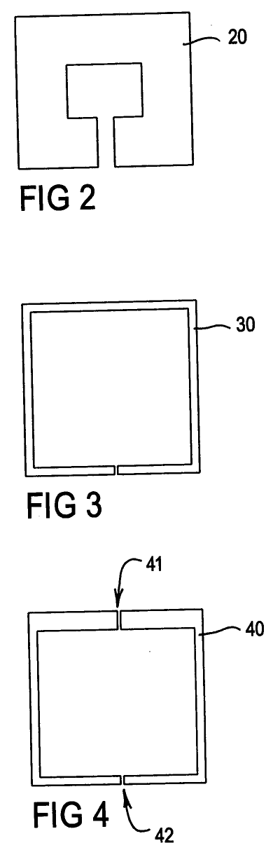

FIG. 2 shows an antenna loop with no matching;

FIG. 3 shows an antenna loop with increased current path radius;

FIG. 4 shows a top layer of an integrated antenna and matching network;

FIGS. 5a and 5b show the bottom layer of the antenna and matching network;

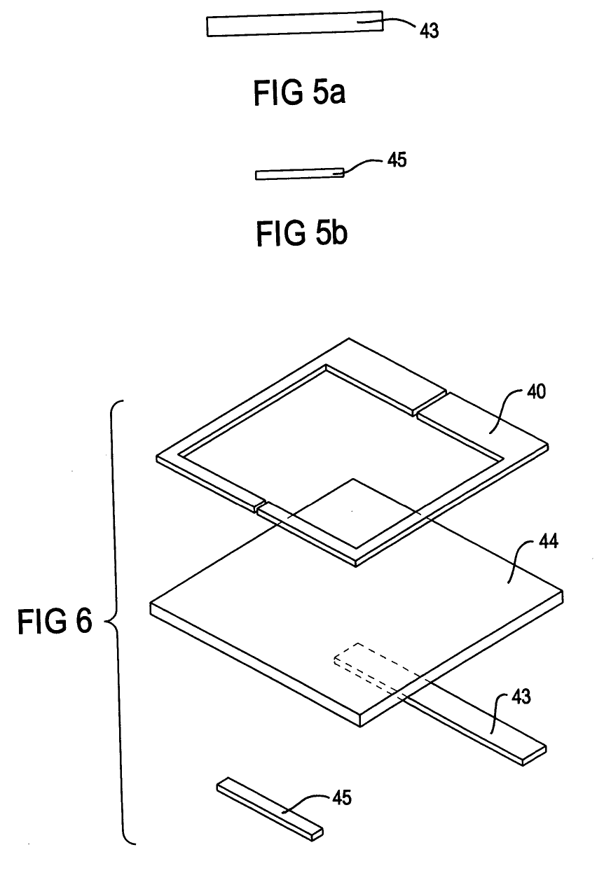

FIG. 6 shows an exploded view of the integrated antenna and matching network;

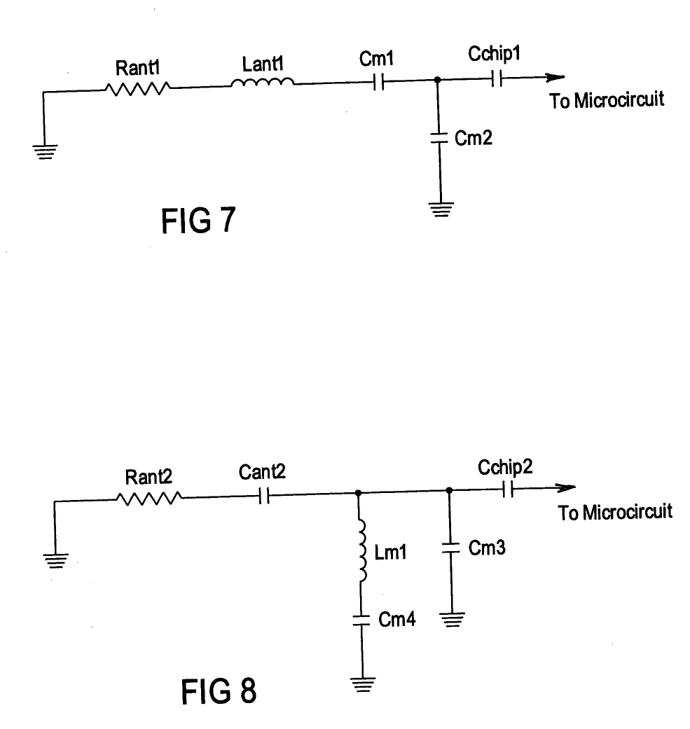

FIG. 7 shows an equivalent circuit of a loop antenna matching network according to the present invention; and

FIG. 8 shows an equivalent circuit of a small electric antenna matching network according to the present invention.

FIG. 1 shows a typical arrangement of an interrogator system in which an interrogator 1 containing a transmitter 2 generates an electromagnetic signal 3 which is transmitted via interrogator antennae 4 to an electronic label 5 containing a label antenna 6. The label antenna 6 is connected via a matching element 7 to an integrated microcircuit 8 via a pair of terminals. Within integrated microcircuit 8 is an integrated matching element 9, preferably a capacitor, connected in parallel with the antenna 6 and matching element 7. The system of antenna 6, matching element 7 and integrated matching element 9 form a resonant circuit at the interrogation frequency so that coupling between the interrogator 1 and the label 5 is enhanced. The label antenna 6 receives a proportion of the transmitted energy and through operation of a rectifier 10 generates a dc power supply for operation of a reply generation circuit 11 connected to the label antenna 6 with the result that an information bearing electromagnetic reply signal 12 is radiated by the label 5.

As a result of electromagnetic coupling between the label 5 and interrogator antennae 4, a portion of a time varying radio frequency signal transmitted by the label antenna 6 may enter the interrogator antennae 4 and in a signal separator 13 located within the interrogator 1 be separated from the signal transmitted by the interrogator 1 and passed to a receiver 14 wherein it is amplified, decoded and presented via a microcontroller 15 in digital or analog form to other systems such as a host computer or a system of sorting gates or the like which may make use of the information provided by the interrogator.

FIG. 2 shows a square planar UHF loop antenna 20 of dimensions 19 mm×19 mm to be matched to an integrated circuit such as microcircuit 8. The inductive reactance (inductance) necessary for matching may be achieved by etching a square hole of dimension 8 mm×8 mm as shown. This results in a loop with a 5.5 mm wide track such that an equivalent filamentary current flows around a 6.75 mm radius. Both the inductance and radiation efficiency of a loop are proportional to its equivalent filamentary radius, so from the stand point of efficiency it is desirable to increase the equivalent radius.

Should the hole in the loop be made larger as shown with reference to loop antenna 30 in FIG. 3 so that the equivalent radius is larger, the inductance rises and no longer resonates (the frequency where the reactances are equal and opposite) at the desired carrier frequency with the capacitance of the associated circuit.

A solution to this problem is to make the hole in the loop (and hence the inductance) as large as possible as shown with reference to loop antenna 40 in FIG. 4, to take full advantage of the larger radius of the circulating currents, and to add in series with this inductance a series capacitance that performs a reactance subtraction. The reactance subtraction may bring the reactance back to the desired magnitude. A point 41 on the loop, typically opposite the loop terminals 42 (used for making a connection to microcircuit 8) may be broken and an additional track 43 as shown in FIGS. 5(a) and 6 may be capacitively coupled to form the series capacitance. The additional track 43 may be coupled using a planar interdigital method, layered construction, or a double sided substrate 44 as shown in FIG. 6. Substrate 44 comprises a dielectric material such as polyethylene terephthalate (PET). Although resonance may be achieved, the resistive part may still be too low, causing a mismatch to exist between the antenna and circuit.

A second step to the matching process is to add in parallel with the inductance a shunt capacitance at the loop terminals 42. The shunt capacitance may be added by making use of parasitic capacitance between the loop terminals 42 or by placing an additional track 45 as shown in FIGS. 5(b) and 6 capacitively coupled to the terminals 42. The shunt capacitance raises both the resistive and inductive part of the impedance. Additional series capacitive reactance may be added to then reduce the inductive reactance back to a desired value. If track 43 is made smaller, a smaller series capacitance will result and hence a larger magnitude negative reactance will be added to the large positive reactance of loop antenna 40, reducing it back to a desired value.

Using a combination of series and shunt capacitances, the impedance of the antenna may be made to be equal to the complex conjugate of the associated circuit impedance, and may thus create a match for maximum power transfer.

When extra series capacitance is required “at the top” of the loop this may be achieved by sacrificing inductance (and making the radiating current path slightly smaller) and making the width of track 43 and the corresponding top part of loop antenna 40 greater. One can also make track 43 into an inverted-U such that its overlap with antenna 40 continues down the sides of the antenna 40. This effectively makes track 43 longer than it otherwise could be with an overall size restriction. The more the inverted U overlaps, the less extra capacitance is obtained as the capacitance becomes distributed and it is better that it be as discrete as possible with respect to the break 41 made at the top of antenna 40.

Also track 43 may be narrowed in width relative to the corresponding top track of antenna 40, and track 45 may be narrowed relative to the bottom track of antenna 40, typically 1 mm in total width less. The reason for this is that the tracks are usually etched in copper (but could be extended to deposited layers) and the lithography process to achieve this relies on aligning the desired layers on opposing sides of the substrate. Any placement error along with small over or under etching (depositing) errors may mean that the centrelines of tracks 43 and 45 are not aligned with the centrelines of the corresponding tracks of antenna 40. If tracks 43 and 45 are narrowed, the capacitor plates may remain fully overlapped by the conductor of antenna 40, minimising error caused by small misalignments.

FIG. 7 shows an equivalent circuit of a loop antenna wherein resistance Rant1 represents the real part of the impedance of the antenna, inductance Lant1 represents the reactive part of the impedance of the antenna and Cchip1 represents the capacitance of an associated microcircuit (not shown) to which the antenna is connected.

A matching network comprising capacitors Cm1 and Cm2 is adapted to modify the impedance of the antenna to be substantially equal to the complex conjugate of the impedance of the microcircuit. Capacitor Cm1 is in series with the antenna and provides a first component for reducing reactance of the antenna. Capacitor Cm2 is in parallel with the antenna and provides a second component for increasing resistance and reactance of the antenna.

FIG. 8 shows an equivalent circuit of a small electric antenna wherein resistance Rant2 represents the real part of the impedance of the antenna, capacitance Cant2 represents the reactive part of the impedance of the antenna and Cchip2 represents the capacitance of an associated microcircuit (not shown) to which the antenna is connected.

A matching network comprising inductor Lm1 and capacitor Cm3 is adapted to modify the impedance of the antenna to be substantially equal to the complex conjugate of the impedance of the microcircuit. Inductor Lm1 is in parallel with the antenna and provides a first component for reducing reactance of the antenna. Capacitor Cm3 is in parallel with the antenna and provides a second component for increasing resistance and reactance of the antenna. The reactance may increase from a negative value to +j200 ohms required to resonate with the microcircuit. It may not be possible to make inductor Lm1 to the correct size due to layout constraints so a larger than needed inductor Lm1 may be used and a capacitor Cm4 may be added in series with inductor Lm1 to reduce the effective inductance. Inductor Lm1 may form part of a Gamma match.

If the small loop's operating bandwidth was the matching condition, then a similar technique may be used except that the resistive part of the antenna may be transformed by the matching network to a magnitude other than the series equivalent resistance of the circuit. By using the value of the parallel equivalent resistance Rp of the circuit, the resistance Rant to which the antenna's series equivalent resistance is transformed, may be found by using the equation

$$f ( BW ) = \frac{f ( centre )}{\sqrt{( Rp / Rant . - 1 )}}$$

The above equation is a useful first order approximation when relatively large bandwidths are desired, such as those currently required for an international UHF tag.

Finally, it is to be understood that various alterations, modifications and/or additions may be introduced into the constructions and arrangements of parts previously described without departing from the spirit or ambit of the invention.

1. A network for matching impedance of an antenna including a first conducting layer to a circuit impedance, said network being adapted to modify at least reactance of said antenna impedance to be substantially equal in magnitude and opposite in sign relative to said circuit impedance and including a first component for modifying said reactance and a second component for modifying resistance and said reactance of said antenna impedance.

2. A network according to claim 1 wherein said network is adapted to modify said antenna impedance to be substantially equal to the complex conjugate of said circuit impedance.

3. A network according to claim 1 wherein said first layer includes a relatively thin metal conductor bonded to a dielectric substrate.

4. A network according to claim 1 wherein said first component forms a capacitance in series with said antenna.

5. A network according to claim 1 wherein said second component forms a capacitance in parallel with said antenna.

6. A network according to claim 1 wherein said first and second components comprise a second conducting layer adjacent said first layer.

7. A network according to claim 1 wherein said first layer is in the form of a loop, said loop including at least one break providing terminals for connecting to said circuit impedance.

8. A network according to claim 6 wherein said second component includes parasitic capacitance between said terminals.

9. A network according to claim 1 wherein said circuit impedance is associated with an integrated microcircuit of an RFID tag.

10. A method for matching impedance of an antenna including a first conducting layer to a circuit impedance, said method being adapted to modify at least reactance of said antenna impedance to be substantially equal in magnitude and opposite in sign relative to said circuit impedance, said method including the steps of:
forming a first component for modifying said reactance; and
forming a second component for modifying resistance and said reactance of said antenna impedance.

11. A method according to claim 10 wherein said network is adapted to modify said antenna impedance to be substantially equal to the complex conjugate of said circuit impedance.

12. A method according to claim 10 wherein said first layer includes a relatively thin metal conductor bonded to a dielectric substrate.

13. A method according to claim 10 wherein said first component provides a capacitance in series with said antenna.

14. A method according to claim 10 wherein said second component provides a capacitance in parallel with said antenna.

15. A method according to claim 10 wherein said first and second components comprise a second conducting layer adjacent said first layer.

16. A method according to claim 10 wherein said first layer is provided in the form of a loop, said loop including at least one break providing terminals for connecting to said circuit impedance.

17. A method according to claim 16 wherein said second component includes parasitic capacitance between said terminals.

18. A method according to claim 10 wherein said impedance is associated with an integrated microcircuit of an RFID tag.
